(19) United States
(12) Patent Application Publication
(10) Pub. No.: US 2008/0315589 A1
(43) Pub. Date: Dec. 25, 2008

(54) Energy Recovery System

(75) Inventor: Lars Malmrup, Lund (SE)

Correspondence Address: MERCHANT & GOULD PC, P.O. BOX 2903, MINNEAPOLIS, MN, 55402-0903, US

(73) Assignee: Compower AB, Lund (SE)

(21) Appl. No.: 11/911,782

(22) PCT Filed: Apr. 19, 2006
(86) PCT No.: PCT/EP06/03574

§ 371 Date: Jun. 25, 2008

(30) Foreign Application Priority Data
Apr. 21, 2005 (SE) 0500902-2

(51) Int. Cl. F02C 6/18; F02C 1/06; F02C 7/08

(52) U.S. Cl. 290/52; 60/39.5; 60/722; 60/648

(57) ABSTRACT

An energy recovery system for a process means (100) comprises a compressor (1), a turbine (2) and a generator (4) being arranged to be driven by a main shaft (3). It also comprises a heat exchanger (5) on a first side being fluidly arranged between the compressor (1) and the turbine (2) and on a second side being fluidly arranged downstream of a process means (100). Heat emanating from exhausts of said process means (100) is transferred to an airflow of the compressor turbine (1, 2) assembly, which airflow is expanded in the turbine (2) which then powers the compressor (1) and the generator (4). Energy is thus recovered from the process, which energy is transformed into electricity so that the overall efficiency of the process is increased.

### FIELD OF THE INVENTION

The present invention relates to a system that can recover energy from heat and/or chemical energy in exhausts of a process means.

### BACKGROUND OF THE INVENTION

The exhausts from different processes, for example a Diesel engine or a chemical process, often contain heat and/or combustible matter. Different solutions have been proposed in order to recover some of this energy. Steam turbines are often used for this purpose on a larger scale, but these systems are not very practical in smaller sizes. They are too expensive and have rather poor efficiency.

### SUMMARY OF THE INVENTION

It is an object of the present invention to provide a system for recovering energy contained in exhausts of a process means, and generate electricity according to the main claim. Other aspects of the invention are given by the dependent claims.

### BRIEF DESCRIPTION OF THE DRAWINGS

The energy recovery system of the present invention will be more readily understood by looking at the appended drawings, where

FIGS. 1-4 are schematical views of different embodiments of said energy recovery system.

### DETAILED DESCRIPTION OF PREFERRED EMBODIMENTS

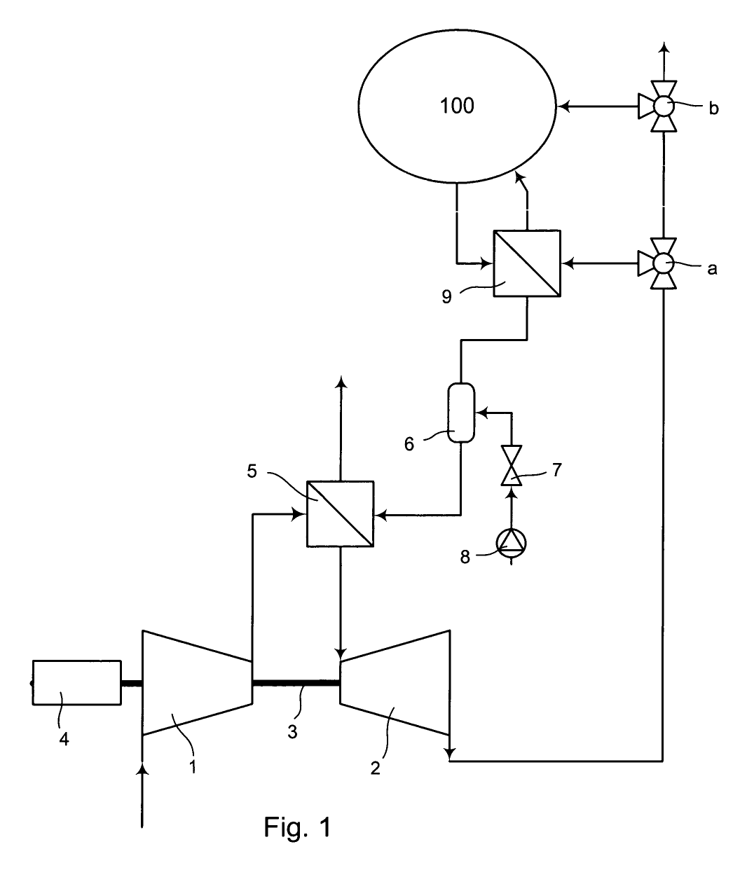

The energy recovery system for a process means 100 of the present invention is based on a Brayton cycle and it comprises a compressor 1 and a turbine 2, see FIGS. 1-4, which are interconnected by a main shaft 3. A generator 4, e.g. a permanent magnet generator, is also mounted on the main shaft 3. The subsystem comprising the compressor 1, turbine 2, main shaft 3 and generator 4 is called a turbogenerator. The system further comprises a high temperature heat exchanger 5, which on one side is connected to the flow that goes through the compressor 1 and the turbine 2. On the other side, the heat exchanger 5 is connected to a flow that comes from a process means 100 from which energy will be recovered, such as a Diesel engine or a chemical process plant.

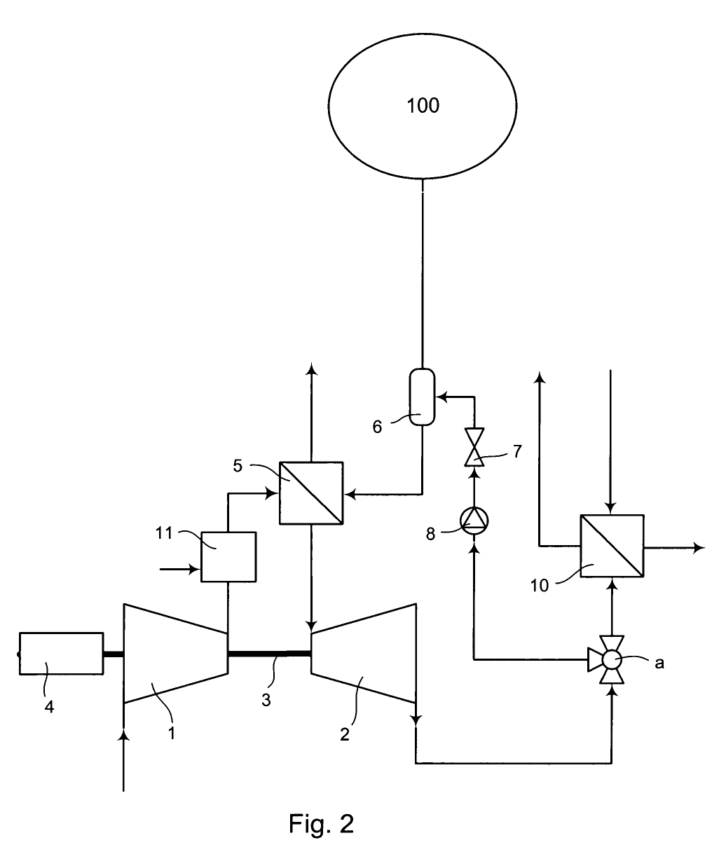

Before the flow reaches the high temperature heat exchanger 5, it may pass a burner 6, where the flow can be heated to a given temperature level. The burner 6 may be provided with a valve 7 and a fan 8 for supplying external air and/or fuel, in the event that the process is supplying insufficient amounts of exhausts for operating the turbogenerator. A heat exchanger 9 can be provided, which on one side is connected to the turbine 2 outlet and on another side is connected to the outlet of the process means 100. An additional heat exchanger 10 (FIG. 2) can be provided to transfer energy from the working flow after the turbine 2 to an auxiliary system, such as an external heating system. A fuel cell 11 (FIG. 2) may be fluidly arranged after the compressor 1 and before the turbine 2.

The high frequency electricity created in the generator 4 is converted to a suitable type of electricity, either DC or AC, by means of power electronics (not shown). The generator 4 can also be operated as a motor during starting of the system. The function of the system is described below, and is illustrated by way of different examples.

The first example of a process means 100 is a Diesel engine where the process flow is exhaust gases that are fed into the burner 6. The temperature of these exhaust gases are typically 500° C. This temperature is increased to more than 800° C. in the burner 6 by supplying additional fuel. This heat is transferred in the high temperature heat exchanger 5 to the working flow, which then drives the rotating main shaft 3 and the generator 4 for generation of electricity. If the Diesel engine 100 is used for propulsion of a truck or a boat, the electricity is preferably used to power some of the auxiliary systems of said truck or boat. The burner 6 uses the excess air in the process flow and fuel that is injected into the process flow. This fuel can be any liquid or gaseous fuel.

The working flow leaving the turbine 2 still contains much heat, and this can be recycled in the heat exchanger(s) 9, 10, for supplying heat to a process 100 or for an external heating system of a boat or truck. The working flow can also be directed to the burner 6 directly or via the valve 7 and/or the fan 8, see FIG. 2, or be supplied to auxiliary systems of the process 100.

In a second example, a chemical process is running in the process means 100, which process has many chemical substances in the exhaust gases, but where the gases not necessarily contain much heat. The exhausts enter the burner 6 where fuel is added and the temperature is increased to at least 800° C. In this combustion, both the added fuel and the chemical substances of the process flow are burned. This means that the total energy content of the substances has been utilised and that the flow coming out of the process is much cleaner, since the chemical substances have been combusted. The heat from the combustion is again transferred to the working flow of a turbogenerator system 1, 2, 3 and 4, where electricity is generated. Surplus electric energy or heat can be supplied to the process 100, according to above, in order to increase the overall efficiency.

Another example of a suitable process 100 is a fuel cell, e.g. a solide oxide or a molten carbonate fuel cell, which is supplied with pressurized air/oxidizer and fuel. The fuel cell generates heat, which together with remaining oxidizer and possibly combustibles may be used to heat the airflow of a turbogenerator according to above. At least a part of the pressurized air/oxidizer for the fuel cell can be taken from the working flow leaving the turbine 2.

The process means 100 may also be an absorption chiller, which is heated by a fuel burner, a gas heater or similar. The air leaving the turbine 2 may also be directed to a burner of this system.

A fuel cell 11 may also be arranged between the compressor 1 and the turbine 2, see FIG. 2. Pressurized air is supplied by the compressor 1 to the fuel cell to react with a suitable fuel, e.g. hydrogen, and the hot exhausts, mainly water vapour, nitrogen and remaining oxygen, are directed towards the turbine 2.

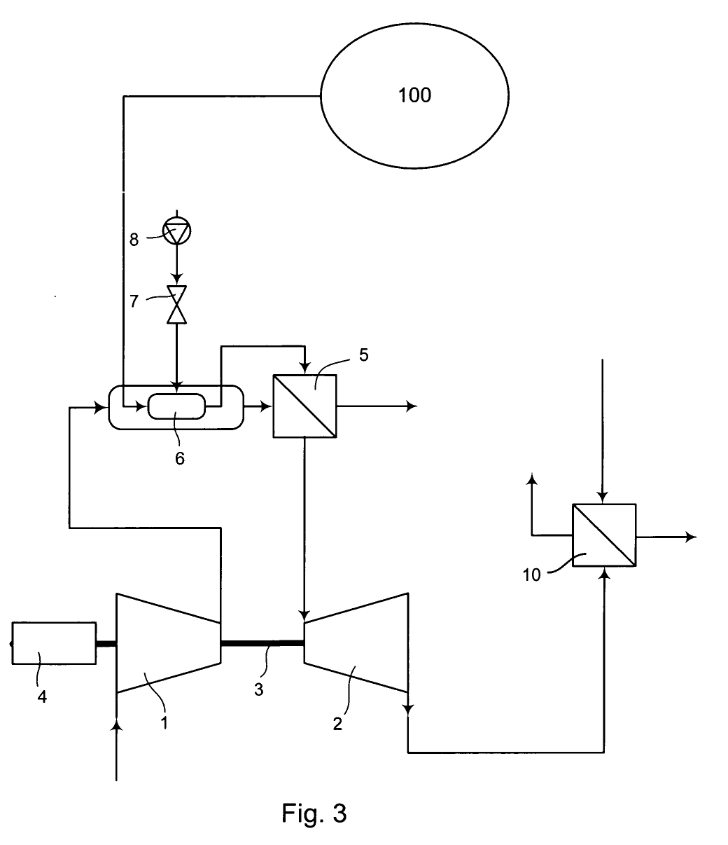

In order to increase the heat transfer to the working flow, the burner 6 can be arranged in close proximity to a pipe of the working flow and even be surrounded by said pipe, see FIG. 3. In this way, more heat can be transferred to the working flow through radiation.

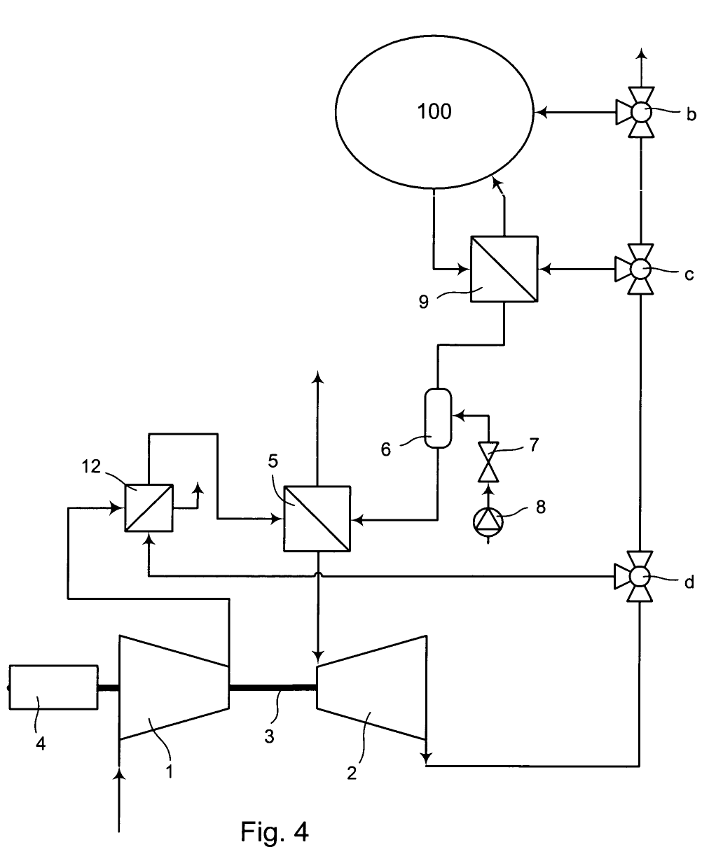

The airflow leaving the turbine 2 can also be directed through a heat exchanger 12, which is positioned downstream of the compressor 1 but upstream of the heat exchanger 5, see FIG. 4.

The energy recovery system for a process means 100 can also provide electric energy for its own auxiliary systems, such as the valve 7 and the fan 8, in order to be self-supporting.

Though specific embodiments are shown in the Figures, it will be apparent to a person skilled in the art to combine features from different figures or to therein incorporate features of the specification without departing from the scope of the invention. Three-way valves a, b, c and d are used to illustrate possible variations of different embodiments, but are not essential for the operation of a system according to the invention.

The term turbogenerator is everywhere intended to refer to an assembly comprising a compressor, a turbine and a high-speed generator being driven by on a main shaft. The heat exchangers are only depicted generally and can have any flow arrangement, e.g. parallel flow, counter flow or cross flow, regardless of the schematical representations in the appended figures.

1. An energy recovery system for a process means (100) comprising
a compressor (1), a turbine (2) and a generator (4) arranged to be driven by a main shaft (3),
a heat exchanger (5) on a first side being fluidly arranged between the compressor (1) and the turbine (2) and on a second side being fluidly arranged downstream of a process means (100), where heat emanating directly or indirectly from exhausts of said process means (100) is transferred to an airflow between the compressor (1) and the turbine (2), which airflow is expanded in the turbine (2) which then powers the compressor (1) and the generator (4),
for recovering energy from the process, which energy is transformed into electricity so that the overall efficiency of the process is increased.

2. A system according to claim 1, wherein the electricity generated by the generator (4) is used to power auxiliary systems of the process (100) and/or the energy recovery system.

3. A system according to claim 1, wherein a burner (6) or a catalytic system is provided between the process exhaust system and the heat exchanger (5).

4. A system according to claim 1, wherein at least a part of the airflow leaving the turbine (2) is used in the process (100).

5. A system according to claim 1, wherein the burner (6) is provided with an air inlet comprising a valve (7) and/or a fan (8) for an introduction of external air and/or fuel.

6. A system according to claim 1, wherein a solid oxide or molten carbonate fuel cell is the process (100) that provides the process exhausts.

7. A system according to claim 1, wherein a fuel system used for the process (100) also is used for the burner (6) of said energy recovery system.

8. A system according to claim 1, wherein the process exhausts emanate from combustion of wood, oat or similar biomass.

9. A system according to claim 1, wherein at least a part of the air leaving the turbine (2) is used to preheat the working flow after the compressor (1) before it enters the heat exchanger (5).

10. A system according to claim 1, wherein at least a part of the air leaving the turbine (2) is used to preheat an external airflow being supplied to the burner (6).

11. A system according to claim 1, wherein at least a part of the air leaving the turbine (2) is supplied directly to the burner (6).

12. A system according to claim 1, wherein at least a part of the air leaving the turbine (2) is passed through a heat exchanger (10) that is arranged for heating a boat or truck where the process (100) is taking place.

13. A system according to claim 1, wherein at least a part of the air leaving the turbine (2) is supplied to an inlet of a fuel cell.

14. A system according to claim 1, wherein at least a part of the air leaving the turbine (2) is directed to a burner adapted for combustion of biomass.

15. A system according to claim 1, wherein the airflow after the compressor (1) passes a fuel cell (11) before entering the turbine (2).

16. A system according to claim 3, wherein the exhausts from the process (100) contains pollutions that are at least partially removed in the burner (6) or the catalytic system, resulting in cleaner exhausts.

17. A system according to claim 1, wherein the process (100) is an absorption chiller and the process gas is taken from after a fuel burner in said chiller and at least a part of the airflow leaving the turbine (2) is directed to an inlet of said fuel burner.
